(19) United States
(12) Patent Application Publication
(10) Pub. No.: US 2022/0283845 A1
(43) Pub. Date: Sep. 8, 2022

(54) SUGGESTION PRESENTATION METHOD AND NON-TRANSITORY COMPUTER-READABLE RECORDING MEDIUM

(71) Applicant: FUJITSU LIMITED, Kawasaki-shi (JP)

(72) Inventors: Tetsuya UCHIUMI, Kawasaki (JP); Ken Yokoyama, Kawasaki (JP)

(73) Assignee: FUJITSU LIMITED, Kawasaki-shi (JP)

(21) Appl. No.: 17/541,071

(22) Filed: Dec. 2, 2021

(30) Foreign Application Priority Data
Mar. 5, 2021 (JP) 2021-035099

(51) Int. Cl. G06F 9/455; G06F 9/50

(52) U.S. Cl. CPC G06F 9/45558; G06F 9/5027; G06F 2009/45583

(57) ABSTRACT

Provided is an improvement suggestion presentation method implemented by a computer, including acquiring first parameters relating to an operation status of a first system, acquiring second parameters relating to operation statuses of second systems, identifying a distribution of each of the second parameters, calculating a difference between one of the first parameters and the distribution of a third parameter, which is a same type as the one of the first parameters, of the second parameters, for each of the first parameters, identifying, from among the first parameters, a resource parameter indicating an amount of allocation of a resource that improves the operation status of the first system, based on the differences, and presenting the resource parameter identified.

### CROSS-REFERENCE TO RELATED APPLICATION

This application is based upon and claims the benefit of priority of the prior Japanese Patent Application No. 2021-035099, filed on Mar. 5, 2021, the entire contents of which are incorporated herein by reference.

### FIELD

A certain aspect of embodiments described herein relates to an improvement suggestion presentation method and a non-transitory computer-readable recording medium.

### BACKGROUND

As the system virtualization technology advances, cloud services that provide virtual machines (VM) booted on physical servers via networks are becoming popular as disclosed in, for example, Japanese Patent Application Publication No. 2012-208781. The user diagnoses the operation status of the virtual machine system using various parameters (e.g., the central processing unit (CPU) utilization) and changes the allocation of resources such as the number of virtual machines according to the diagnosis results.

### SUMMARY

However, since there is no method capable of diagnosing the operation status of a virtual machine system properly, it is difficult for users to improve the operation status of the system.

According to an aspect of the embodiments, there is provided an improvement suggestion presentation method implemented by a computer, including: acquiring first parameters relating to an operation status of a first system; acquiring second parameters relating to operation statuses of second systems; identifying a distribution of each of the second parameters; calculating a difference between one of the first parameters and the distribution of a third parameter, which is a same type as the one of the first parameters, of the second parameters, for each of the first parameters; identifying, from among the first parameters, a resource parameter indicating an amount of allocation of a resource that improves the operation status of the first system, based on the differences; and presenting the resource parameter identified.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a block diagram of an exemplary cloud service system.

FIG. 2 schematically illustrates a physical server.

FIG. 3 illustrates a comparative example of a diagnosis of the operation status of a VM system.

FIG. 4 is a block diagram illustrating a diagnosis server.

FIG. 5 illustrates specific examples of an improvement target parameter and an adjustment target parameter.

FIG. 6 illustrates an output screen of an improvement suggestion message.

FIG. 7 is a functional block diagram illustrating functions of a system diagnosis program generated by a processor.

FIG. 8 illustrates diagnosis target system information and system status information.

FIG. 9 illustrates system classification information.

FIG. 10 illustrates distribution information.

FIG. 11 illustrates the distribution of the amount of communication data and the distribution of the average CPU utilization of the VM system when a system type is not specified and when the system type is specified.

FIG. 12 illustrates extraction of candidates for the improvement target parameter.

FIG. 13 illustrates normalization of parameters.

FIG. 14 illustrates correlation information and resource information.

FIG. 15 illustrates extraction of candidates for the adjustment target parameter.

FIG. 16 illustrates identification of the adjustment target parameter.

FIG. 17 illustrates message definition information.

FIG. 18 is a flowchart (No. 1) illustrating the system diagnosis program.

FIG. 19 is a flowchart (No. 2) illustrating the system diagnosis program.

### DESCRIPTION OF EMBODIMENTS

(System Configuration)

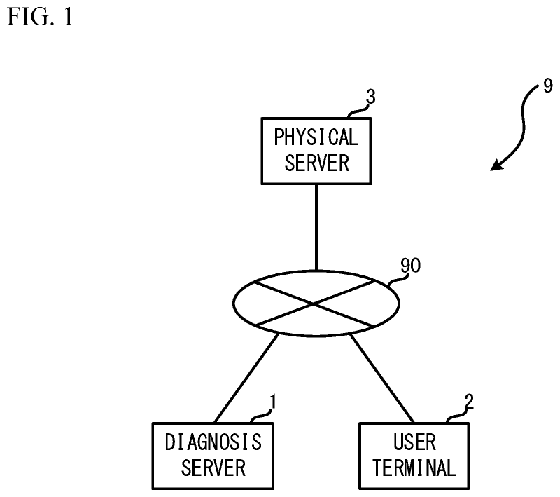

FIG. 1 is a block diagram of an exemplary cloud service system 9. The system 9 implements a cloud service, and includes a diagnosis server 1, a user terminal 2, and a physical server 3. The diagnosis server 1, the user terminal 2, and the physical server 3 are connected to each other via a network 90. Examples of the network 90 include, but are not limited to, the Internet and a local area network (LAN).

Virtual machines are booted on the physical server 3. The virtual machines provide various types of cloud services such as, but not limited to, a Web service and a batch processing service to users via the network 90. Users access virtual machine systems (hereinafter, referred to as VM systems) on the physical server 3 through the user terminal 2 such as a personal computer or a tablet terminal to use the cloud services.

The diagnosis server 1 diagnoses the operation status of the VM system. The diagnosis server 1 presents an improvement suggestion to the user terminal 2 based on the diagnosis result of the VM system.

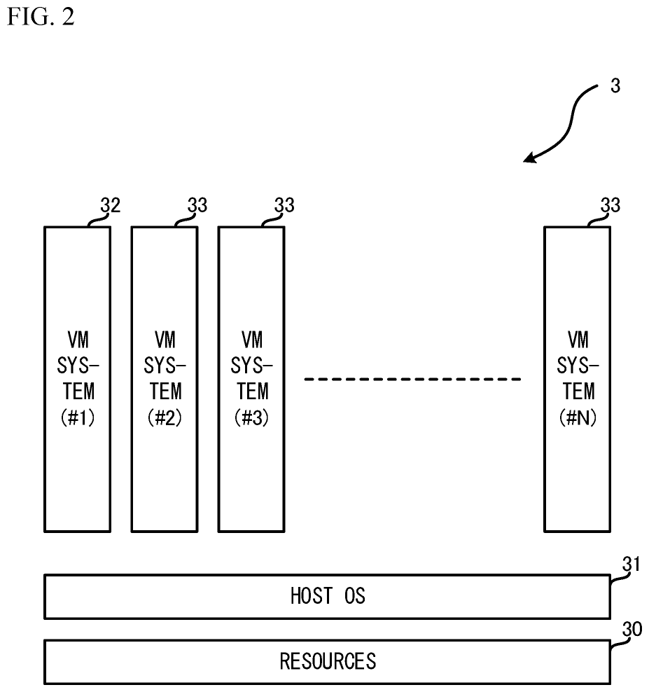

FIG. 2 schematically illustrates the physical server 3. The physical server 3 includes physical resources 30 such as a CPU and a memory, and the resources 30 execute a host operating system (OS) 31. The physical server 3 boots a plurality of virtual machines on the host OS 31. The virtual machines provide various cloud services as VM systems 32 and 33.

The VM system 32 is a system to be diagnosed by the diagnosis server 1. Other VM systems 33 are systems to be compared with the VM system 32 to be diagnosed. The host OS 31 gives a system identification number #1 (hereinafter, described as a system ID) to the VM system 32 to be diagnosed, and system IDs #2 to #N to other VM systems 33, for example. Each of the VM systems 32 and 33 may be implemented by one VM or a plurality of VMs. Each VM is implemented by one CPU or a plurality of CPUs, and executes a process using at least one memory space. The VM system 32 is an example of a first system, and other VM systems 33 are examples of second systems.

As an example, the user uses the VM system 32 through the user terminal 2, and diagnoses the operation status of the VM system 32 using the diagnosis server 1. Other users use the remaining VM systems 33.

### Comparative Example of the System Diagnosis

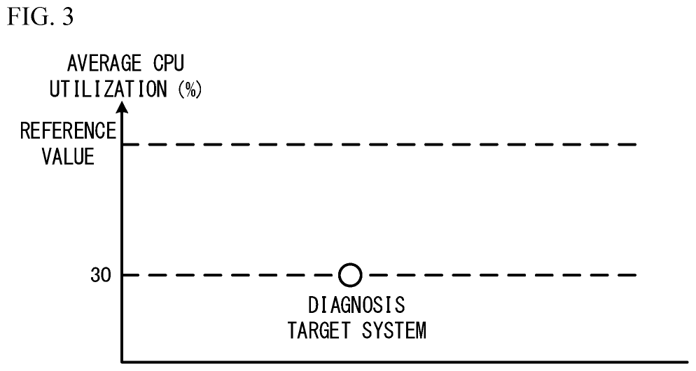

FIG. 3 illustrates a comparative example of the diagnosis of the operation status of the VM system 32. A circle indicates the average CPU utilization (%) of the VM system 32 to be diagnosed (a diagnosis target system). The average CPU utilization is the average value of the CPU utilization within a predetermined time period in the VM system 32.

The user obtains the average CPU utilization from the physical server 3, as the parameter indicating the operation status of the VM system 32. Here, assume that the average CPU utilization of the VM system 32 is 30(%).

The user determines whether the system is operating as expected by diagnosing the operation status of the VM system 32 according to the criteria assumed by the user. For example, the user compares the reference value determined by the user and the average CPU utilization of the VM system 32. Since the average CPU utilization is below the reference value, the user determines that the VM system 32 is operating with a plenty of resources.

However, the user does not know whether the determination is necessarily an appropriate diagnosis result to improve the system. Therefore, the user compares the operation statuses of the VM systems 33 of other users and the operation status of the VM system 32 of the user using the diagnosis server 1.

(Exemplary Configuration of the Diagnosis Server)

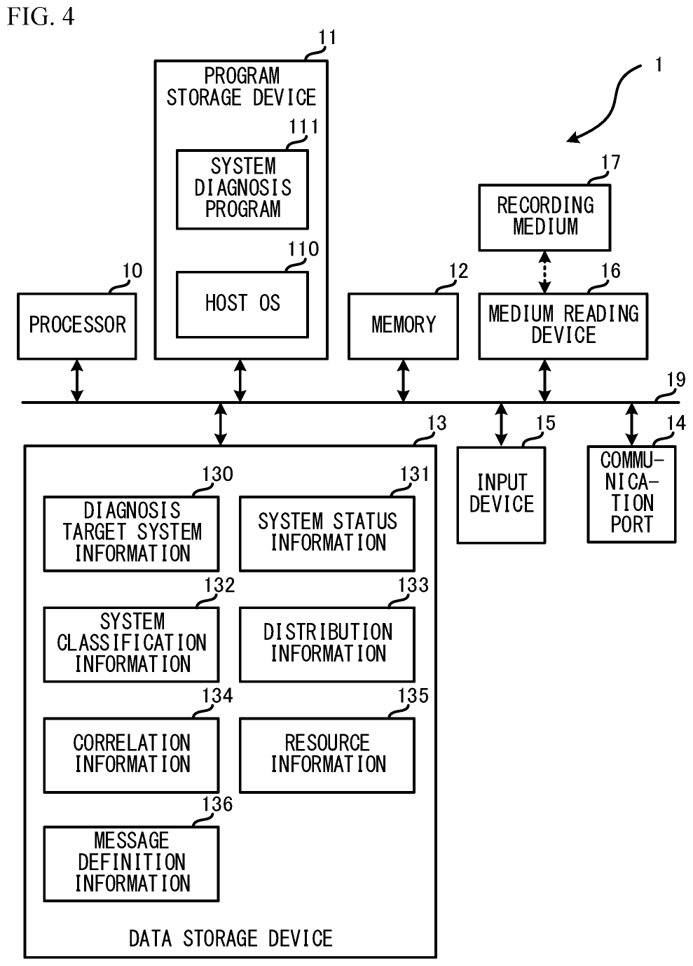

FIG. 4 is a block diagram illustrating the diagnosis server 1. The diagnosis server 1 includes a processor 10 such as a CPU, a program storage device 11, a memory 12, a data storage device 13, a communication port 14, an input device 15, and a medium reading device 16. These components are connected to each other through a bus 19. The diagnosis server 1 is an example of a computer that implements an improvement suggestion presentation method and executes an improvement suggestion presentation program.

The program storage device 11 and the data storage device 13 are non-volatile storages such as, but not limited to, a hard disk drive (HDD) or a solid state disk (SSD). The program storage device 11 stores a host OS 110 and a system diagnosis program 111.

The system diagnosis program 111 is an example of an improvement suggestion presentation program for implementing the improvement suggestion presentation method, and operates on the host OS 110. When executing the system diagnosis program 111, the processor 10 generates various types of functions as described later to diagnosis the operation status of the VM system 32 to be diagnosed and present an improvement suggestion according to the diagnosis result to the user through the user terminal 2.

The system diagnosis program 111 may be stored in a computer-readable recording medium 17, and the processor 10 may be caused to read the system diagnosis program 111 through the medium reading device 16. The recording medium 17 is a physically portable recording medium such as, but not limited to, a compact disc read only memory (CD-ROM), a digital versatile disc (DVD), or a universal serial bus (USB) memory.

The medium reading device 16 is hardware such as, but not limited to, a CD drive, a DVD drive, or a USB interface for reading the recording medium 17. Alternatively, the recording medium 17 may be a semiconductor memory such as a flash memory or a hard disk drive. The recording medium 17 is not a temporary medium such as carrier waves not having a physical form.

Further, the system diagnosis program 111 may be stored in a device connected to a public line, the Internet, a LAN, or the like. In this case, the processor 10 reads the system diagnosis program 111 from the device and executes the system diagnosis program 111.

The memory 12 is hardware that temporally stores data like a dynamic random access memory (DRAM) or the like. The processor 10 loads the system diagnosis program 111 from the program storage device 11 into the address space of the memory 12.

The input device 15 is hardware such as a touch panel, a keyboard, and a mouse for the administrator of the diagnosis server 1 to input the various types of information. The communication port 14 is, for example, a network interface card (NIC), and processes communication between the processor 10 and the physical server 3 and between the processor 10 and the user terminal 2.

The data storage device 13 stores various types of information used during the execution of the system diagnosis program 111. The data storage device 13 stores diagnosis target system information 130, system status information 131, system classification information 132, distribution information 133, correlation information 134, resource information 135, and message definition information 136.

When executing the system diagnosis program 111, the processor 10 acquires the diagnosis target system information 130 relating to the operation status of the VM system 32 to be diagnosed and the system status information 131 relating to each of the operation statuses of other VM systems 33 from the physical server 3 through the network 90. The diagnosis target system information 130 and the system status information 131 include values of various parameters such as the average CPU utilization. The diagnosis target system information 130 is an example of first parameters, and the system status information 131 is an example of second parameters.

The processor 10 compares a parameter of the diagnosis target system information 130 with a parameter, which is the same type as the parameter of the diagnosis target system information 130, of the system status information 131, and identify an improvement target parameter and an adjustment target parameter for improving the operation status of the VM system 32 based on the comparison results. A parameter, which is the same type as the parameter of the diagnosis target system information 130, of the system status information 131 is an example of a third parameter.

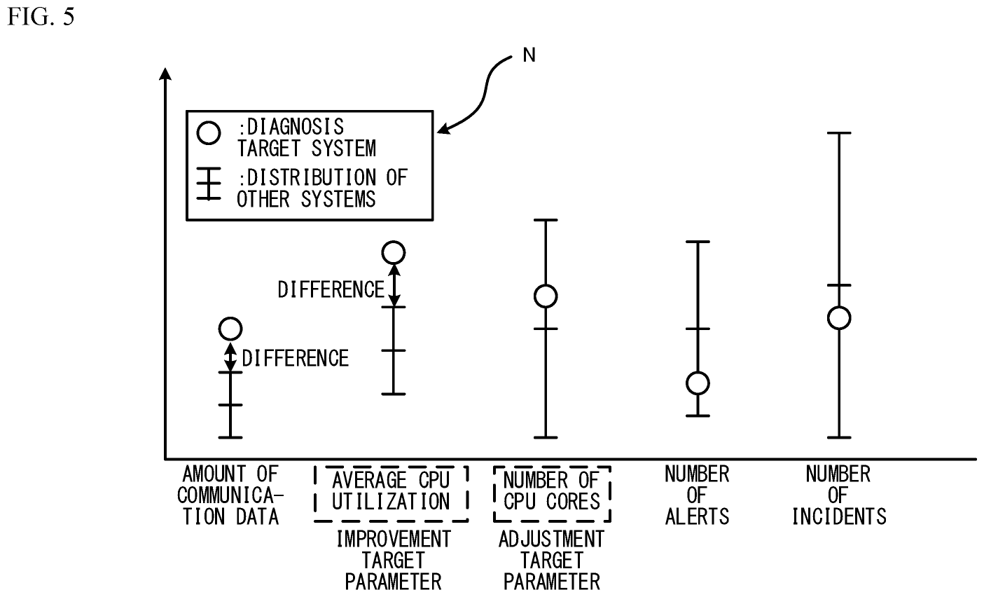

FIG. 5 illustrates identification of the improvement target parameter and the adjustment target parameter. The adjustment target parameter is an example of a resource parameter, and is a parameter that indicates the amount of the allocation of the resource 30 that improves the operation status of the VM system 32, among the parameters of the diagnosis target system information 130. The improvement target parameter is an example of an improvement parameter, and is a parameter that is improved by the adjustment of the amount of the allocation of the resource 30 indicated by the adjustment target parameter, among the parameters of the diagnosis target system information 130.

Examples of the parameters included in the diagnosis target system information 130 and the system status information 131 are the amount of communication data, the average CPU utilization, the number of CPU cores, the number of alerts, and the number of incidents. The amount of communication data is the amount of data within a predetermined time period that the VM system 32, 33 communicated via the network 90. The number of CPU cores is the number of CPU cores allocated to the VM system 32, 33 from the resources 30. The number of alerts is the number of alerts issued by the VM system 32, 33. The number of incidents is the number of complaints raised by the users in the VM system 32, 33.

In FIG. 5, circles indicate the amount of communication data, the average CPU utilization, the number of CPU cores, the number of alerts, and the number of incidents of the VM system 32 to be diagnosed, which are indicated by the diagnosis target system information 130. In addition, scale marks (see the reference character N) indicate the distribution ranges of the amount of communication data, the average CPU utilization, the number of CPU cores, the number of alerts, and the number of incidents of other VM systems 33 based on the system status information 131.

The processor 10 identifies the improvement target parameter, from among the average CPU utilization, the number of CPU cores, the number of alerts, and the number of incidents of the VM system 32 to be diagnosed, based on the differences from the distributions of the same type of parameters of other VM systems 33. The difference means a difference from the upper limit or lower limit of the distribution range. In this example, only the average CPU utilization and the amount of communication data are outside the respective distribution ranges of the parameters. Therefore, the processor 10 determines the average CPU utilization and the amount of communication data as candidates for the improvement target parameter. As an example, the processor 10 identifies the average CPU utilization, which has the largest difference from the distribution, as he improvement target parameter.

The processor 10 also identifies the number of CPU cores as the adjustment target parameter in order to reduce the average CPU utilization. As the number of CPU cores increases, the resources 30 of the VM system 32 increase, and thus the average CPU utilization decreases. The processor 10 presents an improvement suggestion message based on this diagnosis result.

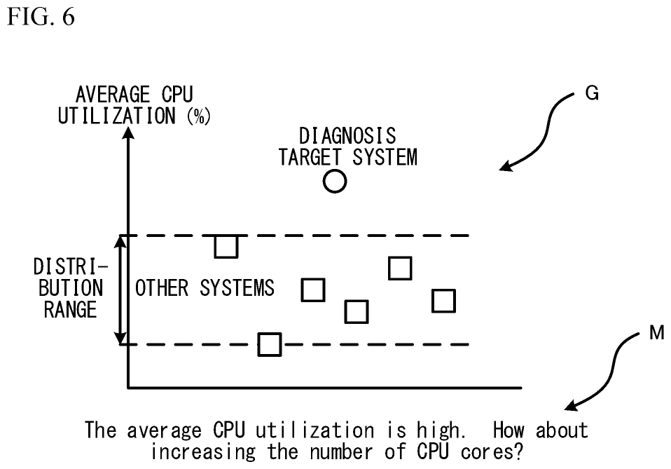

FIG. 6 illustrates an output screen of the improvement suggestion message. The output screen is displayed on, for example, a monitor of the user terminal 2. The reference character G indicates the CPU utilization of the VM system 32 to be diagnosed and the distribution range of the CPU utilization of other VM systems 33. The reference character M indicates the improvement suggestion message that suggests increasing the number of CPU cores because the average CPU utilization is high. The improvement suggestion message allows the user to know the point to be improved of the VM system 32 and the measure to be taken.

(Function of the Processor)

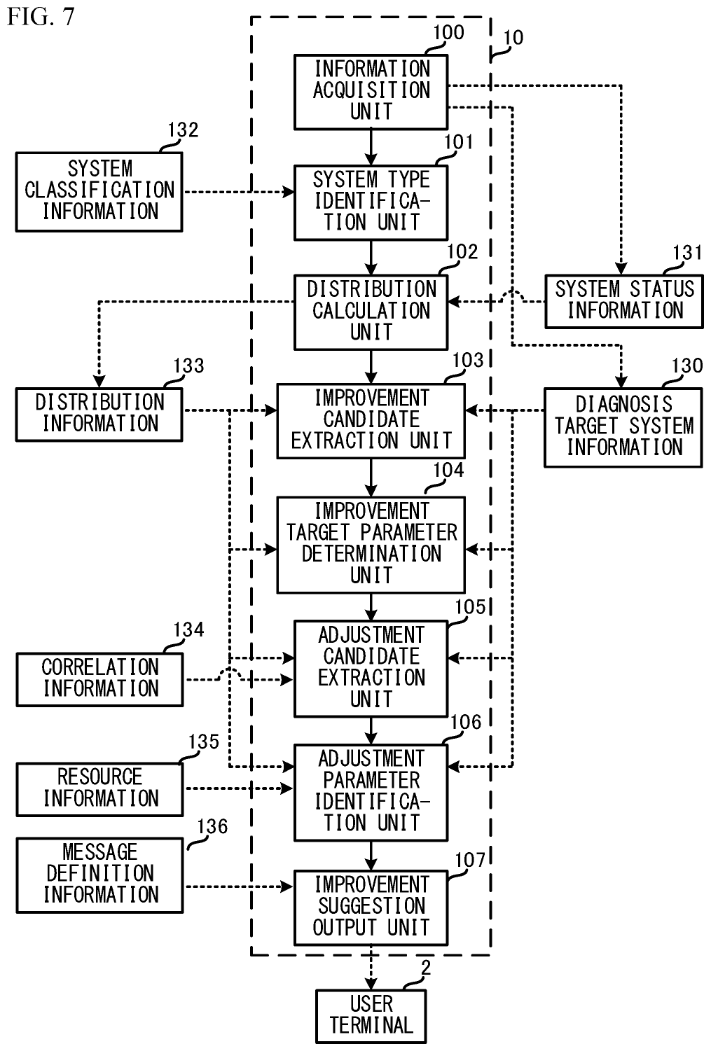

FIG. 7 is a functional block diagram illustrating functions of the system diagnosis program 111 generated by the processor 10. When executing the system diagnosis program 111, the processor 10 generates an information acquisition unit 100, a system type identification unit 101, a distribution calculation unit 102, an improvement candidate extraction unit 103, an improvement target parameter determination unit 104, an adjustment candidate extraction unit 105, an adjustment target parameter identification unit 106, and an improvement suggestion output unit 107.

The information acquisition unit 100 acquires the diagnosis target system information 130 and the system status information 131 from the physical server 3 through the communication port 14. The information acquisition unit 100 may acquire the diagnosis target system information 130 and the system status information 131 from, for example, the input device 15 or the recording medium 17.

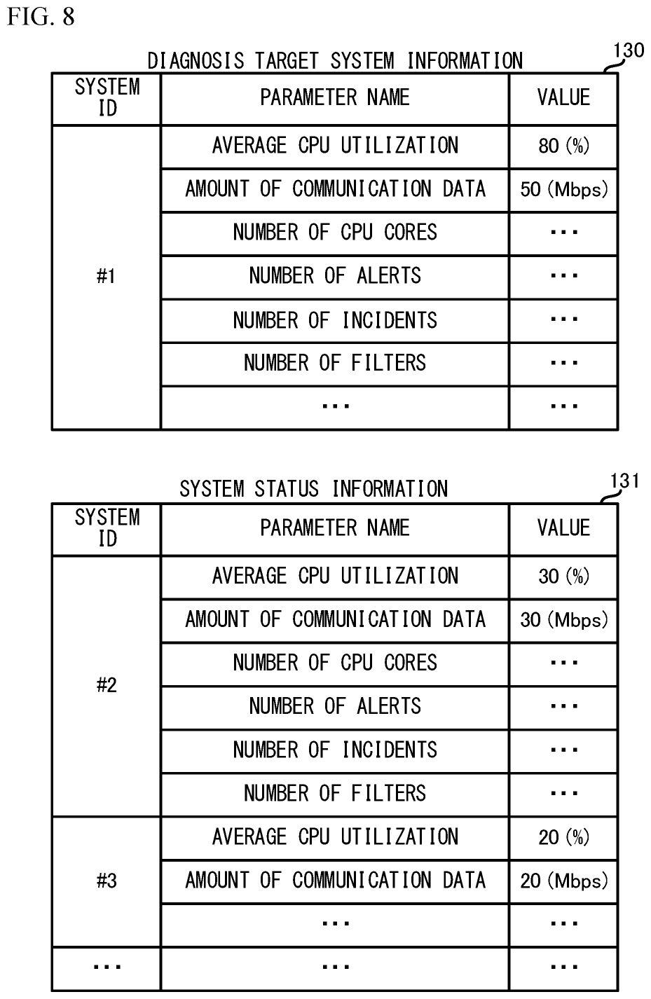

FIG. 8 illustrates the diagnosis target system information 130 and the system status information 131. Each of the diagnosis target system information 130 and the system status information 131 includes a system ID, a parameter name, and a value.

The system ID of the diagnosis target system information 130 is the system ID #1 of the VM system 32 to be diagnosed, and the system ID of the system status information 131 is the system ID #2, . . . of other VM systems 33. The parameter name indicates the amount of communication data, the average CPU utilization, the number of CPU cores, the number of alerts, the number of incidents, and the number of filters. The number of filters is the number of conditions set to limit the sending of the notification mail of the alert issued by the VM system 32, 33.

Referring back to FIG. 7, the information acquisition unit 100 notifies the system type identification unit 101 of the completion of acquisition of the diagnosis target system information 130 and the system status information 131. The system type identification unit 101 identifies other VM systems 33 that provide the same type of cloud service as the VM system 32 based on the system classification information according to the notification.

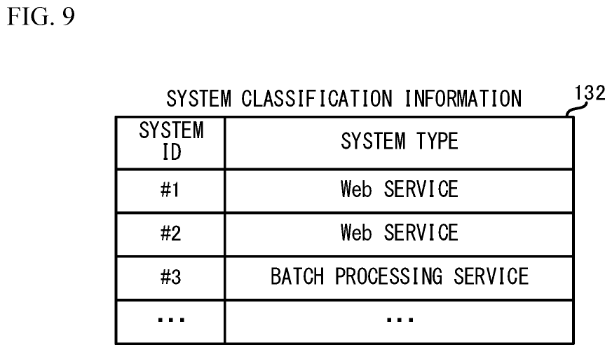

FIG. 9 illustrates the system classification information 132. The system classification information 132 includes the system ID and a system type. For example, the VM system 32 with the system ID #1 and the VM system 33 with the system ID #2 provide Web services, and the VM system 33 with the system ID #3 provides a batch processing service. The system classification information 132 may be acquired from the physical server 3 or may be acquired from the input device 15 or the recording medium 17.

Referring back to FIG. 7, the system type identification unit 101 identifies the system IDs #2, . . . of other VM systems 33 of which the system type is the same as that of the VM system 32 with the system ID #1, from the system classification information 132. The system type identification unit 101 notifies the distribution calculation unit 102 of the identified system IDs #2, . . . .

The distribution calculation unit 102 calculates the distributions of the parameters of the VM systems 33 with the notified system IDs #2, . . . among the parameters of the system status information 131. The distribution calculation unit 102 generates the distribution information 133 indicating the distributions of the parameters of the VM systems 33. Here, the Web service and the batch processing service are described as examples of the system type, but the system type is not limited to these examples.

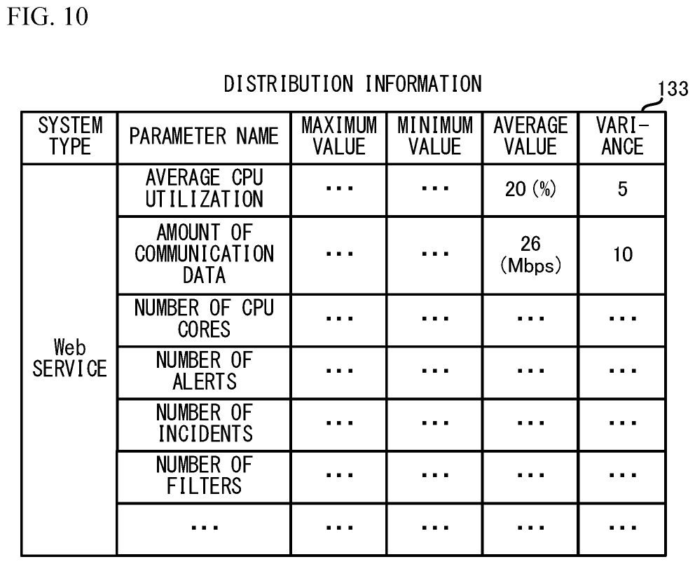

FIG. 10 illustrates the distribution information 133. The distribution information 133 includes the system type, the parameter name, a maximum value, a minimum value, an average value, and a variance. The distribution calculation unit 102 calculates the maximum value, the minimum value, the average value, and the variance for the distribution of each parameter of the VM systems 33 of the same type (in this example, the Web service), based on the system status information 131. Here, the average value is the average value of each parameter of the VM systems 33 providing the Web service among the VM systems 33 excluding the VM system 32 to be diagnosed.

As described above, the system type identification unit 101 identifies the VM systems 33 of the same type as the VM system 32 to be diagnosed, and thus the distribution calculation unit 102 is able to generate the distribution information 133 representing the tendencies of the characteristic parameters common to those of the VM system 32.

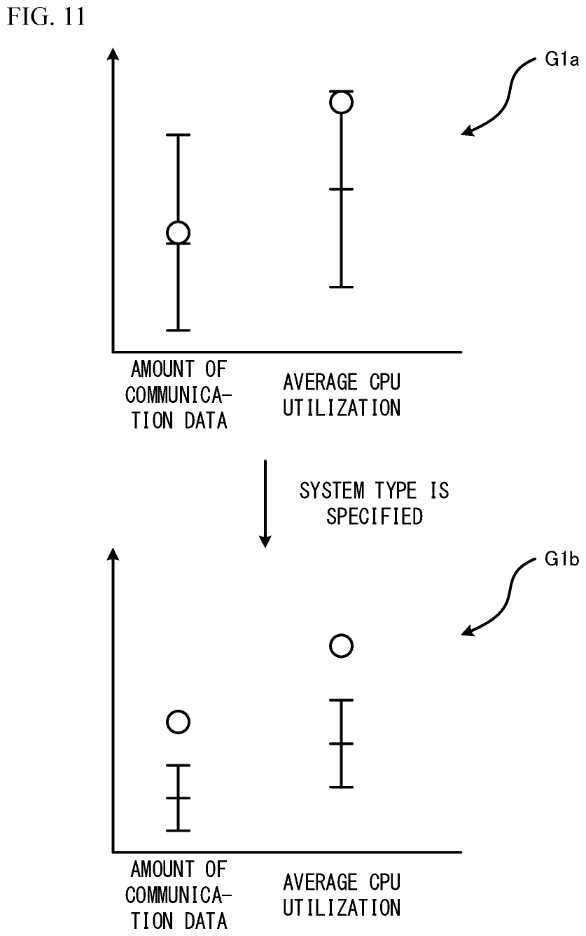

FIG. 11 illustrates the distribution of the amount of communication data and the distribution of the average CPU utilization of the VM systems 33 when the system type is not identified and when the system type is identified. The meanings of the symbols in FIG. 11 are the same as those indicated by the reference character N in FIG. 5.

The reference character G1a indicates the distribution of the amount of communication data and the distribution of the average CPU utilization of the VM systems 33 when the system type is not specified. The reference character G1b indicates the distribution of the amount of communication data and the distribution of the average CPU utilization of the VM systems 33 when the system type is specified. In this example, an example where the VM systems 33 for the batch processing service are identified will be described.

As understood by comparing the case where the system type is not specified and the case where the system type is specified, the distribution of the amount of communication data and the distribution of the average CPU utilization are narrower when the system type is specified. This is because the distribution of the amount of communication data and the distribution of the average CPU utilization exhibit the characteristic tendencies in the batch processing service.

In addition, when the system type is not specified, the amount of communication data and the average CPU utilization of the VM system 32 to be diagnosed are within the respective distribution ranges of other VM systems 33. By contrast, when the system type is specified, the amount of communication data and the average CPU utilization of the VM system 32 to be diagnosed are outside the respective distribution ranges of other VM systems 33.

As seen from the above, by limiting the distribution information 133 to the VM systems 33 of the same type as the VM system 32 to be diagnosed, the diagnosis server 1 can compare the parameters with high accuracy and present a more effective improvement suggestion. When all the VM systems 32 and 33 of the physical server 3 provide the same type of cloud service, there is no need to specify the system type.

Referring back to FIG. 7, the distribution calculation unit 102 notifies the improvement candidate extraction unit 103 of the completion of the generation of the distribution information 133. The improvement candidate extraction unit 103 extracts candidates for the improvement target parameter from among the parameters of the VM system 32 based on the result of the comparison between the diagnosis target system information 130 and the distribution information 133.

For example, the improvement candidate extraction unit 103 calculates the difference between each parameter of the diagnosis target system information 130 and the distribution of the same type of parameter of other VM systems 33. The improvement candidate extraction unit 103 extracts the parameter of which the difference is greater than 0, i.e., the parameter outside the distribution range, as the improvement target parameter.

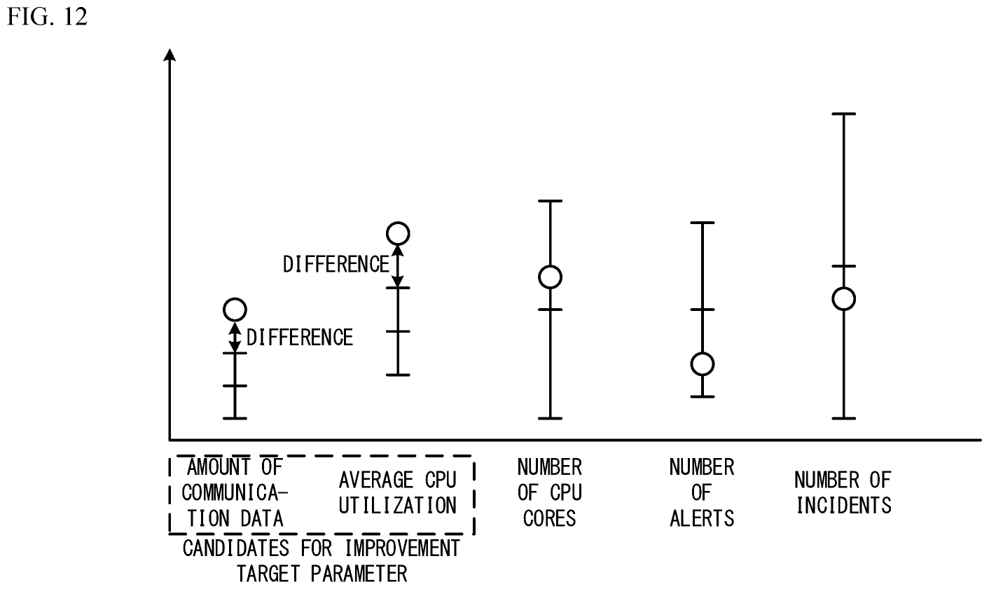

FIG. 12 illustrates extraction of the candidate for the improvement target parameter. The meanings of the symbols in FIG. 12 are as indicated by the reference character N in FIG. 5.

In this example, among the amount of communication data, the average CPU utilization, the number of CPU cores, the number of alerts, and the number of incidents, the amount of communication data and the average CPU utilization are outside the respective distribution ranges (the difference >0). Thus, the improvement candidate extraction unit 103 selects the amount of communication data and the average CPU utilization as the candidates for the improvement parameter. Referring back to FIG. 7, the improvement candidate extraction unit 103 notifies the improvement target parameter determination unit 104 of the candidates for the improvement target parameter.

The improvement target parameter determination unit 104 determines the candidate having the largest difference from the distribution among the candidates for the improvement target parameter, as the improvement target parameter, as an example. The candidate having the largest difference from the distribution is an example of a fourth parameter. However, since the units of the parameters are different, the improvement target parameter determination unit 104 normalizes the parameters of the diagnosis target system information 130 and the distribution information 133.

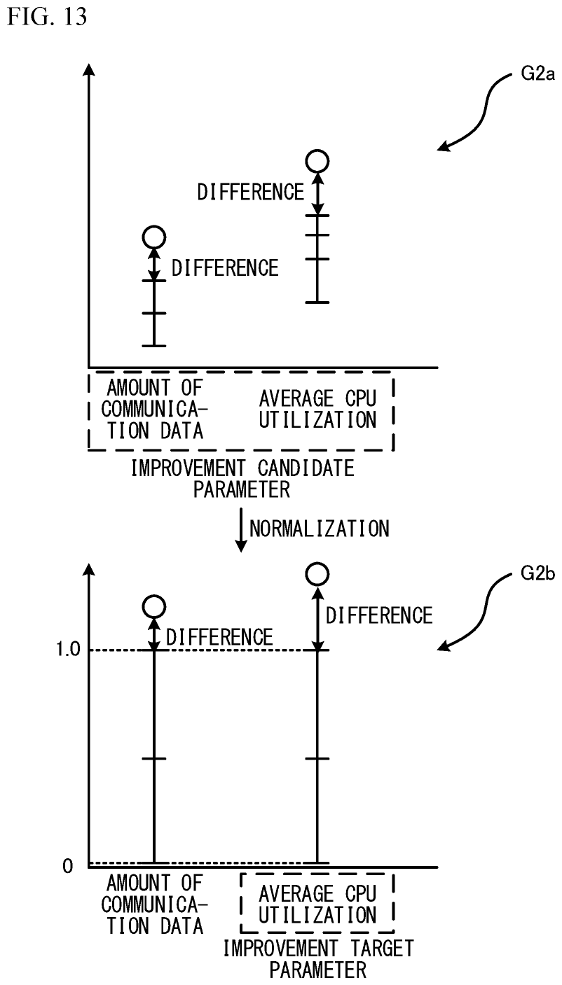

FIG. 13 illustrates the normalization of the parameter. The meanings of the symbols in FIG. 13 are as indicated by the reference character N in FIG. 5.

The reference character G2a indicates examples of the distribution of the amount of communication data and the distribution of the average CPU utilization before normalization. Assume that the improvement candidate extraction unit 103 extracts the amount of communication data and the average CPU utilization as the candidates for the improvement target parameter, as an example. Since the unit of the amount of communication data and the unit of the average CPU utilization are different, it is impossible for the improvement target parameter determination unit 104 to compare the difference from the distribution of the amount of communication data and the difference from the distribution of the average CPU utilization by the same standard when they remain in different units.

The reference character G2b indicates examples of the distribution of the amount of communication data and the distribution of the average CPU utilization after normalization. The improvement target parameter determination unit 104 predicts the respective maximum values of the amount of communication data and the average CPU utilization of each VM system 33 other than the VM system 32 to be diagnosed regardless of the system type.

Maximum value=Average value+2×Variance (1)

The maximum value is calculated using the above equation (1) for each parameter, as an example. The improvement target parameter determination unit 104 normalizes each parameter by dividing each parameter by the maximum value to make the maximum value 1.0. This allows the improvement target parameter determination unit 104 to compare the difference from the distribution of the amount of communication data and the difference from the distribution of the average CPU utilization by the same standard.

In this example, since the difference of the average CPU utilization after the normalization is greater than the difference of the amount of communication data after the normalization, the improvement target parameter determination unit 104 determines the average CPU utilization as the improvement target parameter. As described above, the improvement target parameter determination unit 104 determines the parameter having the largest difference as the improvement target parameter, and thus can present that the parameter with the largest difference from the corresponding distribution of other VM systems 33 is to be improved. The improvement target parameter determination unit 104 may determine, for example, the parameter having the second largest difference as the improvement target parameter instead of the parameter having the largest difference. There are two types of parameters: parameters that need to be improved more as they are larger, and parameters that need to be improved more as they are smaller. For example, for the CPU utilization, as the CPU utilization becomes higher than the distribution, the need to improve the CPU utilization becomes higher. On the other hand, when it is assumed that the system operating rate indicating the ratio of the time during which the VM system 32, 33 is operating normally is added to parameters, as the system operating rate becomes lower than the distribution, the need to improve the system operating rate becomes higher.

Therefore, the improvement target parameter determination unit 104 cannot simply compare the difference from the distribution of the CPU utilization and the difference from the distribution of the system operating rate by the same standard, based on the differences from the distributions.

Thus, the improvement target parameter determination unit 104 corrects the difference by dividing or multiplying the difference from the distribution of the parameter by the average value of the distribution, according to the type of the parameter.

Corrected difference=Difference×Average value of distribution (2)

Corrected difference=Difference±Average value of distribution (3)

The improvement target parameter determination unit 104 corrects the difference from the distribution using the above equation (2) for the parameter that needs to be improved more as it is larger (for example, the CPU utilization and the like). Thus, as the average value is higher, the corrected difference is larger.

In addition, the improvement target parameter determination unit 104 corrects the difference from the distribution using the above equation (3) for the parameter that needs to be improved more as it is smaller (for example, the system operating rate and the like). Thus, as the average value is lower, the corrected difference is larger.

As described above, the improvement target parameter determination unit 104 divides or multiplies the difference from the distribution by the average value of the distribution of the parameter, according to the type of the parameter, and determines the improvement target parameter based on the difference after the division or the multiplication. Therefore, when there are the parameter that needs to be improved more as it is larger and the parameter that needs to be improved more as it is smaller, the improvement target parameter determination unit 104 can compare the differences from the distributions by the same standard regardless of the difference between the types of the parameters by correcting the differences by multiplication or division.

Referring back to FIG. 7, the improvement target parameter determination unit 104 outputs the improvement target parameter and the candidate parameters for the improvement target parameter to the adjustment candidate extraction unit 105.

The adjustment candidate extraction unit 105 extracts the parameters excluding, for example, the candidates for the improvement target parameter, as the candidates for the adjustment target parameter. The adjustment candidate extraction unit 105 notifies the adjustment target parameter identification unit 106 of the candidates for the adjustment target parameter.

The adjustment target parameter identification unit 106 identifies the adjustment target parameter from among the candidates for the adjustment target parameter based on the correlation information 134 and the resource information 135. The adjustment target parameter identification unit 106 identifies the parameter that has a correlation with the improvement of the improvement target parameter based on the correlation information 134. Further, the adjustment target parameter identification unit 106 identifies the parameter that indicates the amount of the allocation of the resource 30 that improves the improvement target parameter, as the adjustment target parameter, from among the candidates for the adjustment target parameter.

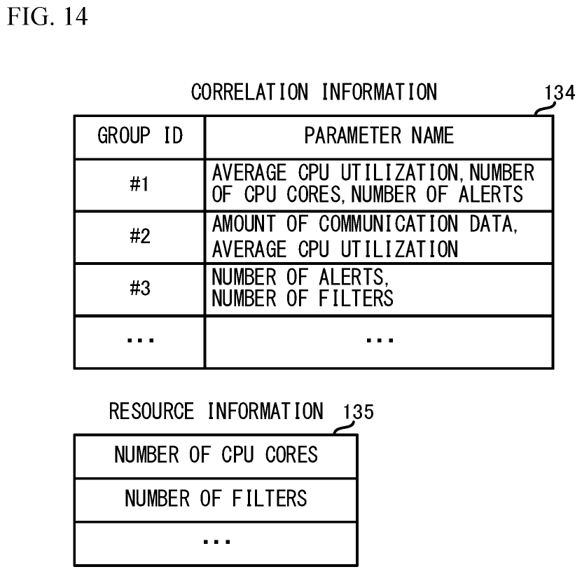

FIG. 14 illustrates the correlation information 134 and the resource information 135. The correlation information 134 includes group IDs #1, #2, #3, . . . and the parameter name. Each group includes a plurality of parameters that have a correlation with each other in improving the operation status of the VM system 32.

For example, for the group ID #1, the change in the number of CPU cores affects the average CPU utilization, and the change in the average CPU utilization affects the number of alerts. For the group ID #2, the change in the amount of communication data affects the average CPU utilization. For the group ID #3, the change in the number of filters affects the number of alerts.

The resource information 135 indicates the parameter name indicating the amount of the allocation of the resource 30 to the VM system 32. Examples of the resource information 135 are, for example, the number of CPU cores and the number of filters. That is, the resource information 135 indicates the parameter that can be adjusted to improve the improvement target parameter.

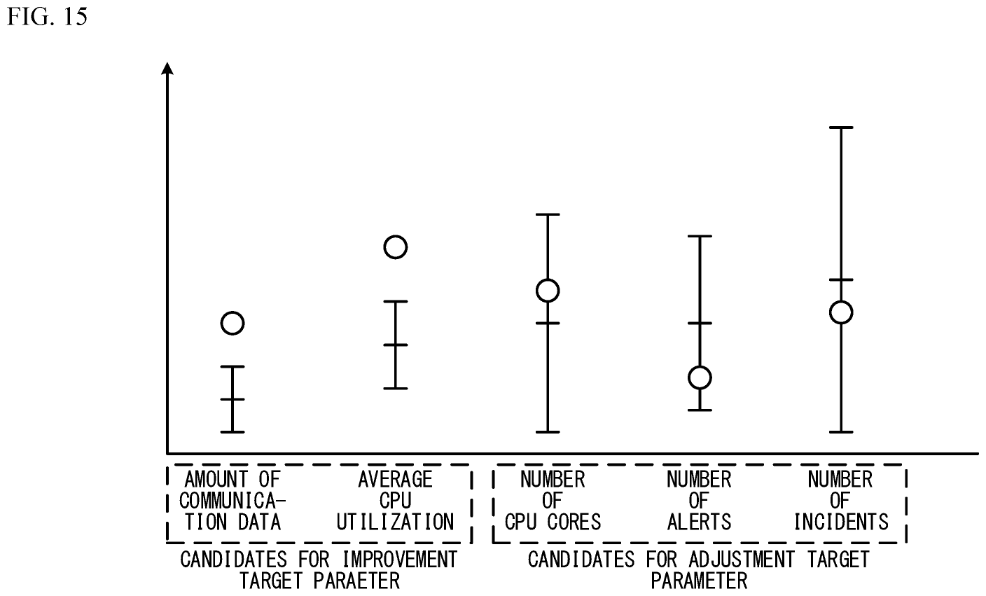

FIG. 15 illustrates extraction of the candidates for the adjustment target parameter. The meanings of the symbols in FIG. 15 are as indicated by the reference character N in FIG. 5.

In this example, as in the example illustrated in FIG. 12, described is an example where the amount of communication data and the average CPU utilization are extracted as the candidates for the improvement target parameter. The adjustment candidate extraction unit 105 extracts the remaining parameters: the number of CPU cores, the number of alerts, and the number of incidents, as the candidates for the adjustment target parameter.

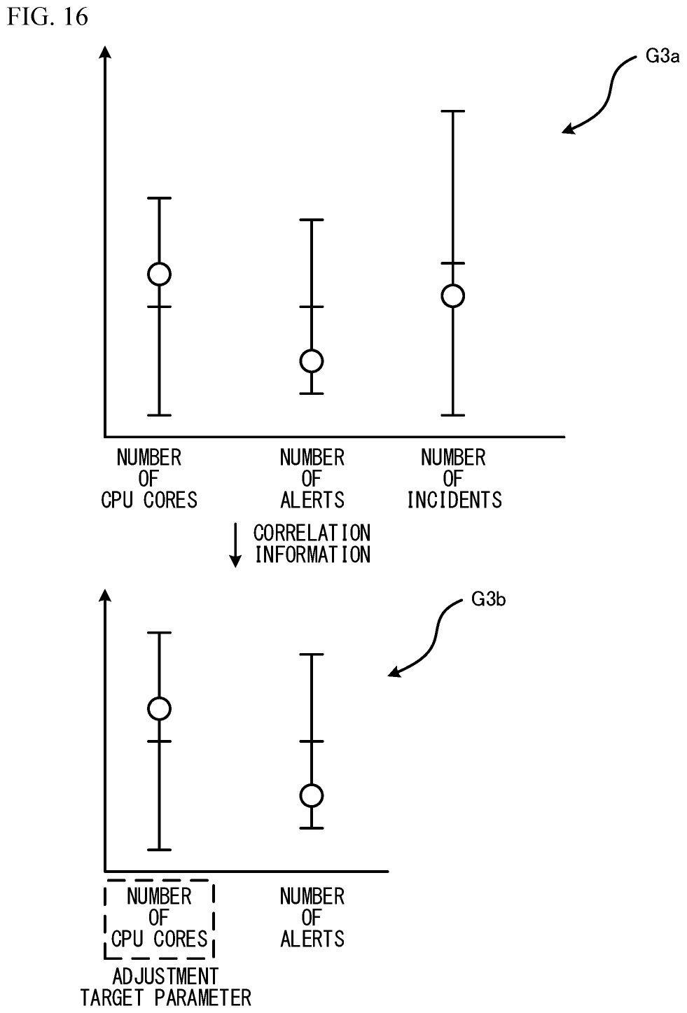

FIG. 16 illustrates identification of the adjustment target parameter. The meanings of the symbols in FIG. 16 are as indicated by the reference character N in FIG. 5.

The reference character G3a indicates the candidates for the adjustment target parameter. In this example, as in the above example, described is an example where the number of CPU cores, the number of alerts, and the number of incidents are extracted as the candidates for the adjustment target parameter. Here, assume that the improvement target parameter is the average CPU utilization.

The reference character G3b indicates the candidates for the adjustment target parameter limited by the correlation information 134. Based on the correlation information 134 illustrated in FIG. 14, among the number of CPU cores, the number of alerts, and the number of incidents, the parameters having a correlation with the average CPU utilization are the number of CPU cores and the number of alerts of the group ID #1. Thus, the adjustment target parameter identification unit 106 selects the number of CPU cores and the number of alerts as the final candidates.

In addition, based on the resource information 135 illustrated in FIG. 14, between the number of CPU cores and the number of alerts, the parameter indicating the amount of the allocation of the resource 30 to the VM system 32 is the number of CPU cores. Therefore, the adjustment target parameter identification unit 106 identifies the number of CPU cores as the adjustment target parameter.

Referring back to FIG. 7, the adjustment target parameter identification unit 106 notifies the improvement suggestion output unit 107 of the improvement target parameter and the adjustment target parameter. The improvement suggestion output unit 107 generates an improvement suggestion message including the improvement target parameter and the adjustment target parameter based on the message definition information 136.

The improvement suggestion output unit 107 outputs the improvement suggestion message to the user terminal 2 through the communication port 14. Therefore, the user can check the improvement suggestion message displayed on the user terminal 2, and improve the operation status of the VM system 32 to be diagnosed, according to the improvement suggestion message.

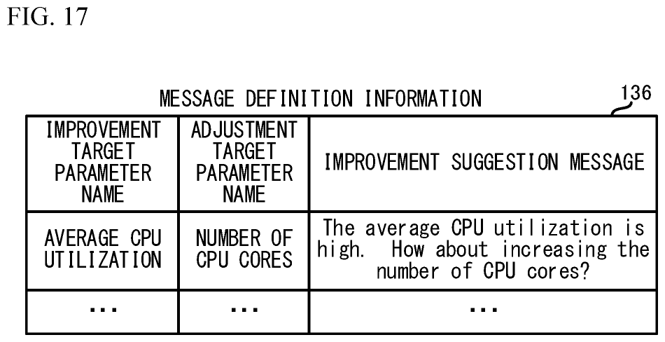

FIG. 17 illustrates the message definition information 136. The message definition information 136 includes an improvement target parameter name, an adjustment target parameter name, and the improvement suggestion message. The improvement target parameter name and the adjustment target parameter name indicates the improvement target parameter and the adjustment target parameter included in the improvement suggestion message, respectively.

The improvement suggestion output unit 107 generates the improvement suggestion message corresponding to the improvement target parameter and the adjustment target parameter. For example, when the improvement target parameter is the average CPU utilization, and the adjustment target parameter is the number of CPU cores, the improvement suggestion output unit 107 generates the improvement suggestion message “The average CPU utilization is high. How about increasing the number of CPU cores?”. The output screen of the improvement suggestion message is as illustrated in FIG. 6, for example.

As described above, the improvement suggestion output unit 107 presents the improvement target parameter and the adjustment target parameter. Thus, the user can know the point to be improved of the VM system 32 to be diagnosed and the measures to be taken.

(Flowchart)

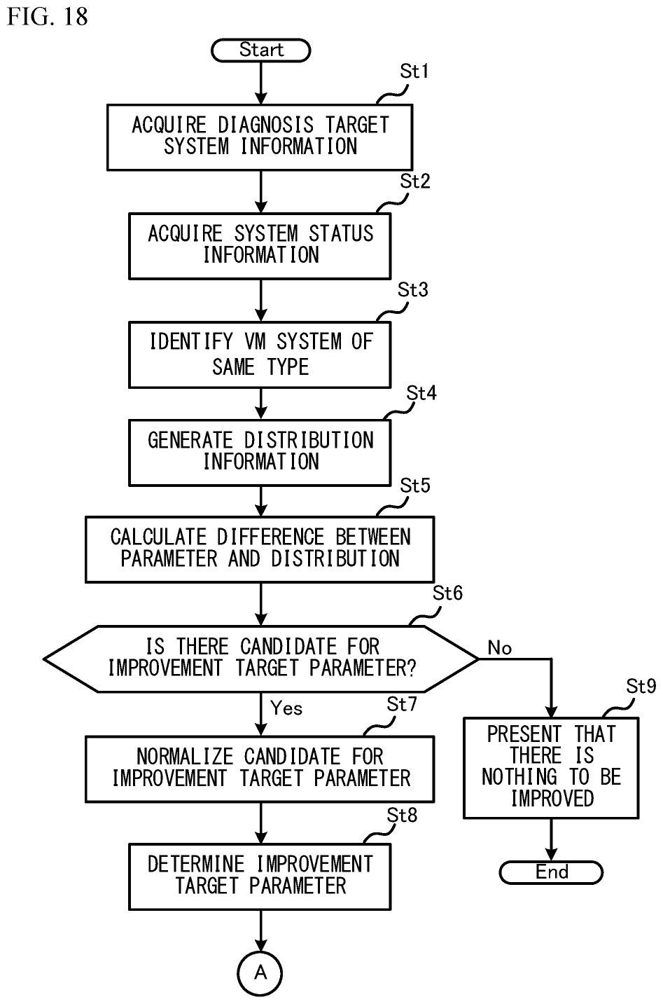

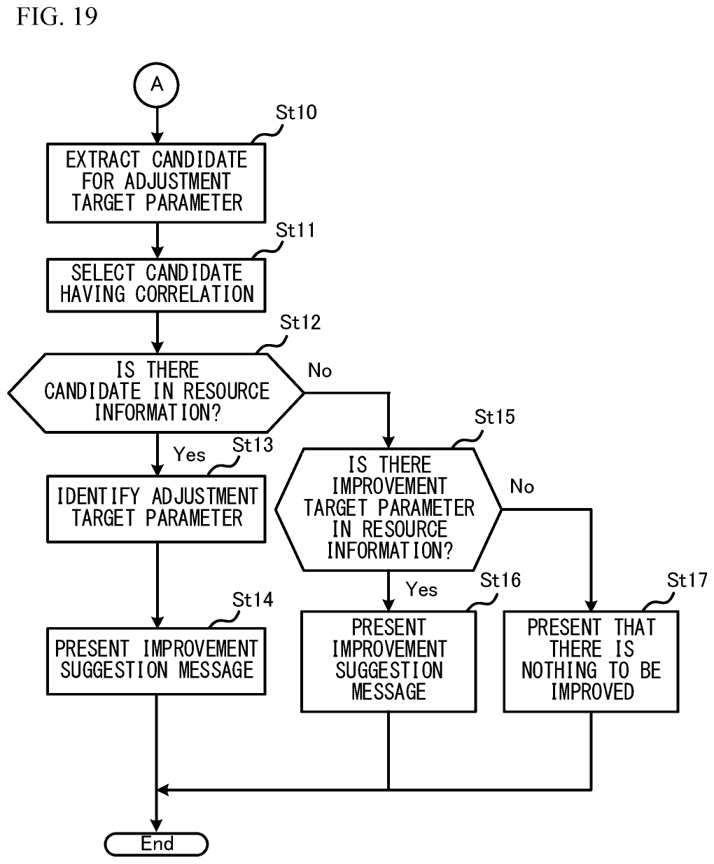

FIG. 18 and FIG. 19 are flowcharts illustrating the system diagnosis program 111. FIG. 18 and FIG. 19 are connected to each other at the symbol “A” to form one flowchart. The diagnosis server 1 executes the system diagnosis program 111 according to the diagnosis request of the VM system 32 from the user terminal 2, for example.

The information acquisition unit 100 acquires the diagnosis target system information 130 from the physical server 3 (step SU). Then, the information acquisition unit 100 acquires the system status information 131 from the physical server 3 (step St2). At this time, the information acquisition unit 100 stores the diagnosis target system information 130 and the system status information 131 in the data storage device 13.

Then, the system type identification unit 101 identifies the VM systems 33 of the same type as the VM system 32 to be diagnosed among the VM systems 33 booted on the physical server 3, based on the system classification information 132 (step St3). Thus, the diagnosis server 1 can limit the VM systems 33 to be compared with the VM system 32 to be diagnosed to the VM systems 33 of the same type as the VM system 32.

Then, the distribution calculation unit 102 generates the distribution information 133 of each parameter of the same type of the VM systems 33 based on the system status information 131 (step St4). This allows the distribution calculation unit 102 to identify the distributions of the parameters of the VM systems 33 with respect to each type.

Then, the improvement candidate extraction unit 103 calculates the difference between each parameter of the diagnosis target system information 130 and the distribution of the same type of the parameter as each parameter based on the distribution information 133 (step St5). Then, the improvement candidate extraction unit 103 determines whether there is a candidate for the improvement target parameter, based on the differences (step St6). Here, the improvement candidate extraction unit 103 extracts the parameter of which the difference from the distribution is greater than 0 as the candidate for the improvement target parameter.

When there is no candidate for the improvement target parameter (No in step St6), the improvement suggestion output unit 107 presents a message indicating that there is nothing to be improved to the user terminal 2 (step St9). Thereafter, the system diagnosis program 111 is finished.

When there is a candidate for the improvement target parameter (Yes in step St6), the improvement target parameter determination unit 104 normalizes the candidate for the improvement target parameter (step St7). This allows the improvement target parameter determination unit 104 to compare the differences from the distributions of the various types of parameters having different units by the same standard, based on the normalized parameters. The improvement target parameter determination unit 104 may correct the difference using the above equation (2) or (3) according to the type of the parameter.

Then, the improvement target parameter determination unit 104 determines the parameter having the largest difference as the improvement target parameter (step St8). Thus, the diagnosis server 1 can determine the parameter having the most significant difference when the VM system 32 to be diagnosed is compared with other VM systems 33, as the improvement target parameter.

Then, the adjustment candidate extraction unit 105 extracts the parameters other than the candidates for the improvement target parameter as the candidates for the adjustment target parameter from among the parameters of the VM system 32 (step St10). Then, the adjustment target parameter identification unit 106 selects the candidate having a correlation with the improvement target parameter from among the candidates for the adjustment target parameter, based on the correlation information 134 (step St11).

Then, the adjustment target parameter identification unit 106 determines whether any one of the candidates for the adjustment target parameter is included in the resource information 135 (step St12). When there is no candidate included in the resource information 135 (No in step St12), the adjustment target parameter identification unit 106 determines whether the improvement target parameter is included in the resource information 135 (step St15).

When the improvement target parameter is not included in the resource information 135 (No in step St15), the improvement suggestion output unit 107 presents the message indicating that there is nothing to be improved to the user terminal 2 (step St17). Thereafter, the system diagnosis program 111 is finished.

When the improvement target parameter is included in the resource information 135 (Yes in step St15), the improvement suggestion output unit 107 generates the improvement suggestion message indicating that the adjustment target parameter and the improvement target parameter are the same as each other, based on the message definition information 136, and presents the generated improvement suggestion message to the user terminal 2 (step St16). Thereafter, the system diagnosis program 111 is finished.

When there is a candidate included in the resource information 135 (Yes in step St12), the adjustment target parameter identification unit 106 identifies the candidate included in the resource information 135 as the adjustment target parameter (step St13). Then, the improvement suggestion output unit 107 generates the improvement suggestion message including the adjustment target parameter and the improvement target parameter based on the message definition information 136, and presents the improvement suggestion message to the user terminal 2 (step St14). Thereafter, the system diagnosis program 111 is finished.

The system diagnosis program 111 operates in the above manner.

The system diagnosis program 111 causes the diagnosis server 1 to acquire parameters relating to the operation status of the VM system 32 to be diagnosed, and parameters relating to the operation statuses of other VM systems 33. The diagnosis server 1 identifies the distribution of each parameter of the VM systems 33, and calculates the difference between one of the parameters of the VM system 32 to be diagnosed and the distribution of a parameter, which is the same type as the one of the parameters of the VM system 32, of the VM systems 33, for each of the parameters of the VM system 32. The diagnosis server 1 identifies the adjustment target parameter indicating the amount of the allocation of the resource that improves the operation status of the VM system 32 from among the parameters of the VM system 32 based on the differences between the parameters of the VM system 32 and the respective distributions.

Therefore, the diagnosis server 1 is able to present the amount of the allocation of the resource that improves the operation status of the VM system 32 based on the result of the comparisons between the parameters of the VM system 32 to be diagnosed and the respective distributions of the parameters of other VM systems 33 with respect to each type. Therefore, the diagnosis server 1 is able to diagnose the operation status of the VM system 32 appropriately by the comparison with the operation statuses of other VM systems 33, instead of user's criteria as illustrated in FIG. 4.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention.

What is claimed is:

1. An improvement suggestion presentation method implemented by a computer, comprising:
acquiring first parameters relating to an operation status of a first system;
acquiring second parameters relating to operation statuses of second systems;
identifying a distribution of each of the second parameters;
calculating a difference between one of the first parameters and the distribution of a third parameter, which is a same type as the one of the first parameters, of the second parameters, for each of the first parameters;
identifying, from among the first parameters, a resource parameter indicating an amount of allocation of a resource that improves the operation status of the first system, based on the differences; and
presenting the resource parameter identified.

2. The improvement suggestion presentation method according to claim 1, further comprising:
determining an improvement parameter to be improved by adjustment of the amount of the allocation of the resource among the first parameters based on the differences; and
presenting the improvement parameter determined.

3. The improvement suggestion presentation method according to claim 2, wherein the determining of the improvement parameter includes determining a fourth parameter that has a largest difference among the first parameters as the improvement parameter.

4. The improvement suggestion presentation method according to claim 2, further comprising:
dividing or multiplying the differences by average values of the distributions of the second parameters according to types of the first parameters,
wherein the determining of the improvement parameter includes determining one of the first parameters as the improvement parameter based on the differences after division or multiplication.

5. The improvement suggestion presentation method according to claim 1, further comprising:
normalizing the first parameters and the second parameters; and
calculating the difference based on the first parameters normalized and the second parameters normalized.

6. The improvement suggestion presentation method according to claim 1, further comprising:
identifying the second systems of a same type as the first system.

7. A non-transitory computer-readable recording medium storing a program that causes a computer to execute a process, the process comprising:
acquiring first parameters relating to an operation status of a first system;
acquiring second parameters relating to operation statuses of second systems;
identifying a distribution of each of the second parameters;
calculating a difference between one of the first parameters and the distribution of a third parameter, which is a same type as the one of the first parameters, of the second parameters, for each of the first parameters;
identifying, from among the first parameters, a resource parameter indicating an amount of allocation of a resource that improves the operation status of the first system, based on the differences; and
presenting the resource parameter identified.

8. The non-transitory computer-readable recording medium according to claim 7, the process further comprising:
determining an improvement parameter to be improved by adjustment of the amount of the allocation of the resource among the first parameters based on the differences; and
presenting the improvement parameter determined.

9. The non-transitory computer-readable recording medium according to claim 8, wherein the determining of the improvement parameter includes determining a fourth parameter that has a largest difference among the first parameters as the improvement parameter.

10. The non-transitory computer-readable recording medium according to claim 8, the process further comprising:
dividing or multiplying the differences by average values of the distributions of the second parameters according to types of the first parameters,
wherein the determining of the improvement parameter includes determining one of the first parameters as the improvement parameter based on the differences after division or multiplication.

11. The non-transitory computer-readable recording medium according to claim 7, the process further comprising:
normalizing the first parameters and the second parameters; and
calculating the difference based on the first parameters normalized and the second parameters normalized.

12. The non-transitory computer-readable recording medium according to claim 7, the process further comprising:
identifying the second systems of a same type as the first system.
